(19) United States
(12) Patent Application Publication
(10) Pub. No.: US 2005/0168322 A1
(43) Pub. Date: Aug. 4, 2005

(54) Method for the remote control of doors and/or lids for vehicles and associated remote control system

(75) Inventors: Nils Appenrodt, Ulm (DE); Carsten Lorenz, Sindelfingen (DE); Rainer Scholz, Bad Liebenzell (DE); Heiko Wohlgemuth, Ditzingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/016,776

(22) Filed: Dec. 21, 2004

(30) Foreign Application Priority Data
Dec. 22, 2003 (DE) 103 61 115.0

(51) Int. Cl. H04Q 1/00; G05B 19/00

(52) U.S. Cl. 340/5.72; 340/5.61

(57) ABSTRACT

In a method for the remote control of doors and/or lids of vehicles, the act of approaching the vehicle and/or the position of an authentication element is detected. The authentication element communicates with a vehicle-sided transmitter and/or receiver for opening at least one door and/or lid. The communication for opening at least one door and/or lid is enabled by a predetermined manual control action before approaching the vehicle and/or by a predetermined sequence of movements of the authentication element after it reaches the vehicle.

### BACKGROUND AND SUMMARY OF THE INVENTION

This application claims the priority of German Application No. 103 61 115.0, filed Dec. 22, 2003, the disclosure of which is expressly incorporated by reference herein.

The invention relates to a method and apparatus for remote control of doors or lids for vehicles.

Modern vehicles are frequently equipped with automatic opening systems for hatch lids, trunk lids or doors, by means of a remote control unit, which actuates the central lock unit of the vehicle. A common problem associated with such systems is that when the vehicle user approaches the vehicle with a load to be deposited in the vehicle (for example, after shopping or during transport of baggage) he or she must first deposit the load next to the vehicle in order to open the trunk lid, hatch lid or door of the vehicle with the remote control unit. In particular in bad weather the load has to be put on the wet ground, where it can become soiled or convey moisture and dirt into the vehicle.

German patent document DE 199 12 319 A1 discloses a so-called keyless go system for authorized access, in which each lock unit of a vehicle door or hatch lid is assigned a recognition sensor with a specific area of detection. In this area of detection a status inquiry signal is beamed out; and in the event that an authentication element (a keyless go key, which is designed, for example, as a chip card with a transponder) is detected, the authentication communication is initiated. In the presence of an authorizing keyless go key, the lock unit, assigned to the detection area, is actuated; or optionally control commands for all lock units of the vehicle can also be generated, so that either only the vehicle door, allocated to the actuated first lock unit, is unlocked or all vehicle doors are unlocked simultaneously. The selective unlocking of a specific vehicle door and/or vehicle lid is effected by a person with the keyless go key approaching the vehicle in such a manner that the authentication element is brought into the detection area of the door and/or the lid to be opened, so that the respective door and/or lid is opened. If, however, the person, who would like to open the hatch lid, does not have a free hand, for example because he or she is carrying objects with both hands, then he has to first deposit these objects, before he can open the hatch lid. This feature can be a drawback, especially in the case of darkness, rain or tight conditions around the vehicle.

A keyless go system, disclosed in German patent document DE 100 38 803 A1, solves this problem with a vehicle-dedicated system for the purpose of voice input by a person, so that, when this person approaches the motor vehicle, he or she can enter, for example, the voice command “open hatch lid”. However, such a system is very complicated because it requires a voice recognition system and an external microphone.

German patent document DE 103 20 255.2, which was not published first, discloses an access authorization system for vehicles with at least one keyless go key as the authentication element for unlocking vehicle doors and/or vehicle lids. To open automatically the vehicle doors and/or vehicle lids, there is an additional transponder, which sends a corresponding signal for opening at least one door and/or lid, assigned to the transponder, within a receiving area of a vehicle-sided transmitter/receiver The additional transponder can be connected to a mobile object, provided for transport by means of the vehicle, and can thus open the desired door/and or lid.

One object of the present invention is to provide a method and apparatus for the remote control of doors and/or lids for vehicles, which makes it possible to open automatically the doors and/or the lids, and to virtually prevent inadvertent opening of doors and/or lids.

This and other objects and advantages are achieved by the remote control system according to the invention, which is based on the idea that communications for opening at least one door and/or lid is enabled by means of a predetermined manual control action before approaching the vehicle and/or by means of a predetermined sequence of movements after having approached the vehicle. The manual control action enables the user to prepare the opening action of at least one door and/or lid outside the range of the dedicated transmitters and/or receivers, i.e. at a greater distance from the vehicle, before the user picks up the loads and goes to the vehicle.

The predetermined control action, which may consist, for example, of actuating an actuating element on a portable authentication element twice within a predetermined period of time, triggers in the authentication element a first authentication signal, comprising an opening command for at least one door and/or lid, which it sends, for example, cyclically. The range of the first authentication signal is such that a dedicated vehicle-sided receiver does not receive it until the user with the authentication element reaches a first area, which corresponds, for example, to the area, in which the user has the vehicle in his field of vision.

In one feasible design, when the user reaches the predetermined first area, the first authentication signal activates at least one proximity sensor in the vehicle, which detects that the authentication element is drawing closer. The proximity sensor triggers the opening of at least one door and/or lid, when the user with the authentication element reaches a predetermined second area, the limits of which are closer to the vehicle than the limits of the first area.

In this manner the user can trigger the authentication signal with the open command at a greater distance from the vehicle, outside the reciprocal range of the transmitters and/or receivers disposed in the vehicle and in the authentication element, so that the user can pick up the load and approach the vehicle with it. Not until the user with the load moves into the visual range of the vehicle does the predetermined range of the first authentication signal prepare the opening of at least one door and/or lid. At least one door and/or lid opens only after the user has reached the second area, monitored by the proximity sensor, and thus has moved into the immediate vicinity of the vehicle. Thus, it is guaranteed that at least one door and/or lid does not open until immediately prior to the arrival of the user so that, for example, when it is raining, no moisture gets into the interior of the vehicle. In addition, it can be provided that the opening of at least one door and/or lid is not carried out until the proximity sensor has also recognized the predetermined sequence of movements, performed by the user for the opening action.

In an alternative design, upon reaching the predetermined first area, the first authentication signal activates a transmitter in the vehicle. The latter sends cyclically a vehicle-related second authentication signal with a shorter range than the first authentication signal. If upon drawing closer with the authentication element, the user reaches the second area, then the authentication element answers the second authentication signal with the command signal to open at least one door and/or lid. The range of the second authentication signal is selected in such a manner that the user is located in the immediate vicinity of the vehicle, when the authentication element can receive the signal. Additional communication by way of the second authentication signal and the respective opening signal guarantees that no unauthorized person can open any door or lid, before the user reaches the immediate vicinity of the vehicle and can prevent unauthorized access.

In another design the transmission of the first authentication signal can be delayed and can be triggered only after the expiration of a predetermined first period of time following execution of the manual control action; and/or the first authentication signal can be sent out cyclically within a predetermined second period of time. In this manner the energy consumption of the authentication element can be decreased. The first and second period of time is chosen in such a manner that it is guaranteed that the first authentication signal is sent, when the user reaches the first area.

The first authentication signal can be sent with reduced power by means of the portable authentication element, compared to its usual use for controlling the central locking of the vehicle.

In an alternative design the opening of at least one door and/or lid is triggered by means of the predetermined sequence of movements in the immediate vicinity of the vehicle. This feature has the advantage that the user does not have to think about activating the open function before picking up the loads. The vehicle recognizes the predetermined sequence of movements, for example, by means of a proximity sensor by detecting, for example, the distance from the authentication element or by detecting its proximity to or distance from the user or an object, in order to open then at least one door and/or lid of the vehicle after an authentication operation by means of the authentication element, preferably part of a keyless go system.

For authentication of the user, the proximity sensor activates a transmitter in the vehicle, when the user with a vehicle-dedicated authentication element reaches a predetermined second area. Then the transmitter sends an authentication signal, which is answered by the authentication element with a corresponding response signal. If the predetermined sequence of movements is also recognized within the second area, then at least one door and/or lid is opened automatically.

The predetermined sequence of movements consists, for example, of the user approaching the vehicle up to a first distance and then retreating up to a second distance from the vehicle by, for example, moving one step back again. Preferably the duration of time, within which the user must stay in the first distance, is predetermined, so that the predetermined sequence of movements is recognized as such.

Furthermore, it can be provided that the time duration of the predetermined sequence of movements is defined, and so that said sequence is recognized as such, only when the duration of time, starting from the recognition of the user up to the range in the second area, matches the predetermined and defined duration of time. In so doing, this predetermined duration of time can be defined by a minimum or maximum duration of time.

The remote control system can be designed, for example, in such a manner that with the inventive method, only the hatch door or the hatch lid of the vehicle is opened automatically. In principle, however, the remote control system can also be designed in such a manner that several doors and/or lids can be opened automatically. The choice of which door is opened following the user's approach, can be made by the user, for example, by way of the manual actuating sequence. In addition, a specific area of detection can be assigned to the individual vehicle doors and/or vehicle lids by means of the respective proximity sensors, as described, for example, in the aforementioned German patent document DE 199 12 319 A1. Then after activating the authentication signal by means of the user approaching the desired door and/or lid, the user determines the opening of the same. If the opening of at least one door and/or lid is triggered by the user's predetermined sequence of movements, then the user performs this sequence of movements in the detection area of the desired door and/or lid.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a remote control system for doors and/or lids of a vehicle;

FIG. 2 is a first embodiment of a method for the remote control of doors and/or lids of a vehicle;

FIG. 3 is a second embodiment of a method for the remote control of doors and/or lids of a vehicle; and

FIG. 4 is a third embodiment of a method for the remote control of doors and /or lids of a vehicle.

### DETAILED DESCRIPTION OF THE DRAWINGS

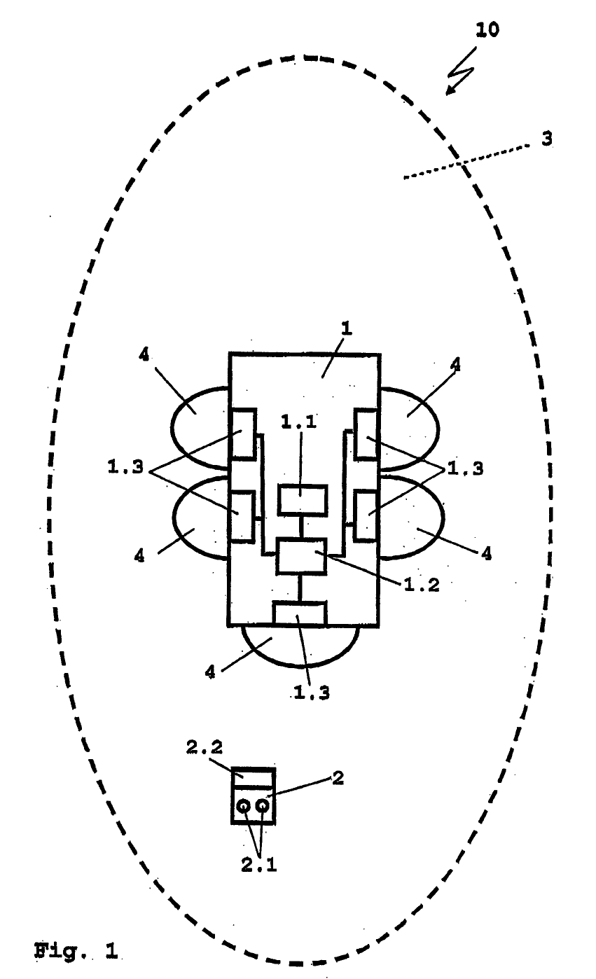

As evident from FIG. 1, the remote control system 10 for doors and/or lids of vehicles 1 comprises a mobile authentication element 2 with at least one actuating element and a transmitter and/or receiver 2.2, a vehicle-sided transmitting and/or receiving unit 1.1, which drives an actuating mechanism (not illustrated) of at least one door and/or lid, when the vehicle-sided transmitting and/or receiving unit 1.1 receives an opening command from the transmitting and/or receiving unit 2.2 of the authentication element 2. An evaluating and/or control unit 1.2 is connected to the vehicle-sided transmitter and/or receiver 1.1 and to at least one proximity sensor 1.3 (for example, as an optical, capacitive or inductive sensor or as an infrared or ultrasonic sensor), for the purpose of exchanging electrical signals (for example, by way of a databus). In the illustrated embodiment, five proximity sensors 1.3 are used, each of the four vehicle doors being assigned one proximity sensor 1.3, and one of the proximity sensors 1.3 being assigned to the hatch lid or hatch cover. Each of the proximity sensors 1.3 is assigned a detection area 4 for monitoring.

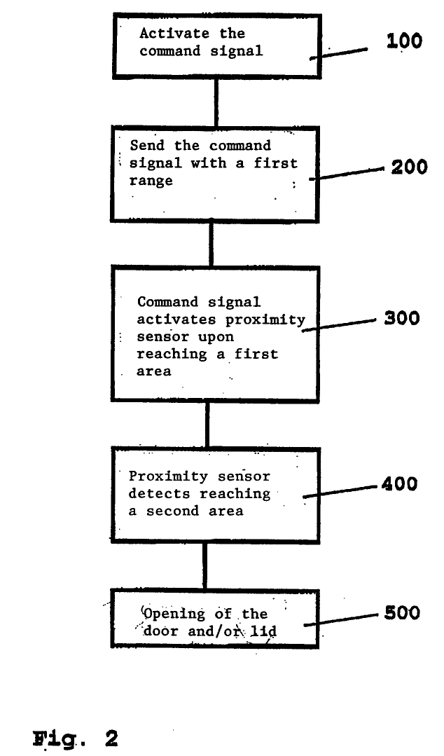

FIG. 2 depicts a first embodiment of the inventive method. In step 100, a command signal is activated by means of a predetermined actuating action, and is sent out with a first range in step 200. The predetermined actuating action is performed by the user outside the range of the command signal, before the user picks up loads that must be carried to the vehicle. After the actuating action, the user picks up the loads and moves toward the vehicle. The transmission power of the command signal can be reduced, compared to the range of the normal remote control signal, in order to guarantee that the user is in the visual range of the vehicle 1 even in the event of overshoot, when the vehicle-sided transmitting and/or receiving unit 1.1 receives the command signal to unlock and /or to open at least one door and/or lid. In step 300 the command signal activates at least one proximity sensor 1.3 in the motor vehicle, when the user with the authentication element 2 reaches a first area 3, shown with the dashed line in FIG. 1. In step 400 said at least one proximity sensor 1.3 monitors a second area 4 and recognizes when the user has reached this second area 4 in the course of approaching the vehicle 1. When the user reaches this second area 4, then in step 500 the proximity sensor 1.3 activates by means of the evaluating and/or control unit the actuating mechanism of the respective door and/or lid; and the door and/or lid is opened automatically so that the user can stow away the load.

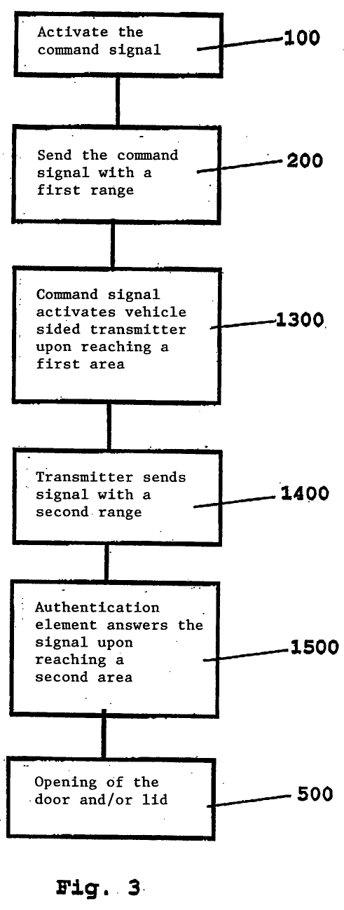

FIG. 3 depicts a second embodiment of the inventive method, where steps 100, 200, and 500 are equivalent to those in the first embodiment. In contrast to the method, according to FIG. 2 however, in the second embodiment the command signal in step 1300 activates the transmitter and/or receiver 1.1 in the motor vehicle 1, when the user with the authentication element 2 reaches the first area 3, shown with a dashed line in FIG. 1. In step 1400 the vehicle-sided transmitting and/or receiving unit 1.1 sends cyclically a vehicle-related second authentication signal with a shorter range than the first authentication signal. This signal can be, for example, a low frequency signal, which is sent by a shock absorber antenna. As the authentication element 2 continues to approach the vehicle, the authentication element 2 answers this signal by means of a response signal, which triggers the opening of the doors and/or lids in step 500, when the authentication element 2 reaches the second area 4. In a second embodiment, the limits of the second area 4 are determined by the range of the second authentication signal, which is sent by the vehicle-sided transmitter and/or receiver 1.1. That is, the function of the proximity sensors 1.3 is carried out by the vehicle-sided transmitter and receiver 1.1

To reduce the energy requirement, the first authentication signal can be sent only after expiration of a predetermined first period of time following execution of the manual control operation. In addition, both the signals, sent by the authentication element 2, and the signal, sent by the vehicle, can be sent only within a predetermined second period of time.

The predetermined manual control action can be equivalent in the authentication element to, for example, a one-time actuation of its own actuating element 2 in the authentication element 2 or a repeated, preferably twice, actuation of an actuating element for opening the hatch lid. As already stated, this control action is performed prior to picking up the load.

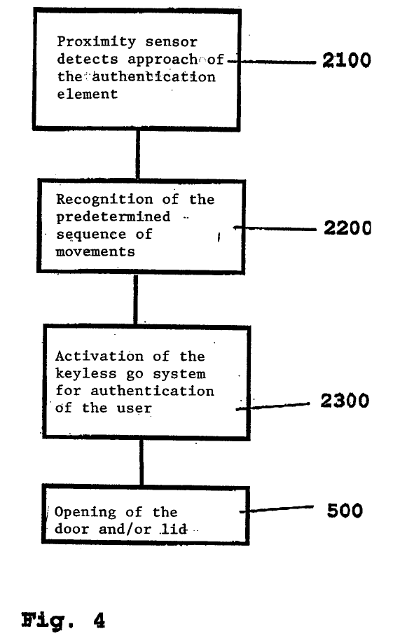

FIG. 4 depicts a third embodiment of the inventive method, where in step 2100 at least one proximity sensor 1.3 monitors its respective detection area 4. The monitoring can be performed cyclically or continuously. When the user with the authentication element 2 approaches the vehicle 1 and when in step 2200 at least one proximity sensor 1.3 recognizes a predetermined sequence of movements in the second area 4, then in step 2300, for example, the keyless go system is activated for authentication of the user. If the result is positive, that is, the user is an authorized user, then the opening of at least one door and/or lid is triggered in step 500. For authentication of the user, the proximity sensor activates by means of the evaluating and/or control unit the vehicle-sided transmitter and/or receiver 1.1. Said transmitting and/or receiving unit sends a first authentication signal, for example a wake-up signal, to the transmitter and/or receiver 2.1 in the authentication element 2. The authentication element answers the first authentication signal with a second authentication signal, which comprises the opening command. When the vehicle-sided transmitting and/or receiving unit 1.1 receives the second authentication signal, the corresponding opening function in the vehicle 1 is performed. The predetermined sequence of movements consists, for example, of the user approaching the vehicle 1 up to a first distance within the second area 4 and then distancing himself from the vehicle again up to a second distance from the vehicle by, for example, moving back again one step. For the purpose of recognizing this sequence of movements, the proximity sensor measures the distance and/or finds the position of the authentication element 2.

According to the inventive method, the user can trigger by means of the manual control action the opening operation of at least one door and/or lid outside the range of the associated transmitters and/or receivers, that is, at a greater distance from the vehicle, before the user picks up the loads and moves toward the vehicle. In so doing, at least one door is opened, only after the user is in the immediate vicinity of the vehicle, thus virtually preventing unauthorized access.

By specifying the sequence of movements for opening at least one door and/or lid, an intuitive opening in the immediate vicinity of the vehicle is possible without the user having to think about activating a function prior to picking up the load.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for the remote control of vehicle closures members, in which at least one of i) an authentication element approaching the vehicle, and ii) position of a respective authentication element is detected, the authentication element communicating with a vehicle-sided transmitter and/or receiver for opening at least one closure member, wherein:
communication for opening the at least one closure member is enabled by at least one of a predetermined manual control action of the authentication element before approaching the vehicle and a predetermined sequence of movements of the authentication element after reaching the vehicle.

2. The method, as claimed in claim 1, wherein the control action triggers in the authentication element a first authentication signal, with a first range, which is sent cyclically by the authentication element, whereby the first authentication signal comprises an opening command for the at least one closure member.

3. The method, as claimed in claim 2, wherein when the authentication element reaches a predetermined first area corresponding to the first range, the first authentication signal activates at least one proximity sensor which is located in the vehicle and which detects continued approach of the authentication element and triggers opening of the at least one closure member when the authentication element reaches a predetermined second area.

4. The method, as claimed in claim 2, wherein when the authentication element reaches a predetermined first area corresponding to the first range, the first authentication signal activates a transmitting and/or receiving unit, which is located in the vehicle and which sends cyclically a vehicle-related second authentication signal with a second range, shorter than the first range, which is answered by a response signal when the authentication element approaches close enough so as to reach the second area, thus triggering opening of the at least one closure member.

5. The method, as claimed in claim 4, wherein at least one of the following is true:
transmission of the first authentication signal is triggered after expiration of a predetermined first period of time following execution of the manual control action; and
the first authentication signal is sent out cyclically within a predetermined second period of time.

6. The method, as claimed in claim 5, wherein the transmission of the first authentication signal occurs with reduced transmission power.

7. The method, as claimed in claim 5, wherein the predetermined manual control action comprises a repeated actuation of an actuating element of the authentication element.

8. The method, as claimed in claim 1, wherein a proximity sensor detects an approach of one of the authentication element, a person and an object, where:
at least one proximity sensor activates a transmitter and/or receiver in the vehicle when one of the authentication element, the person and the object reaches a predetermined second area; and
the predetermined sequence of movements is recognized, that the transmitting and/or receiving unit sends an authentication signal, which is answered by the authentication element for opening at least one closure member.

9. The method, as claimed in claim 8, wherein for the authentication within the second area, a keyless go system is used as the authentication element.

10. The method, as claimed in claim 9, wherein the predetermined sequence of movements is recognized by a proximity sensor when one of the authentication element, a person and an object approaches to a first distance from the vehicle within the second area, and then retreats again up to a second distance from the vehicle.

11. The method, as claimed in claim 10, wherein a dwell period of the authentication element, person or object in the first distance corresponds at least to a predetermined and defined duration of time.

12. The method, as claimed in claim 11, wherein distance to the authentication element, person or object is measured by the proximity sensor.

13. The method, as claimed in claim 11, wherein the approach of the authentication element, person or object is measured by the proximity sensor.

14. The method, as claimed in claim 9, wherein the predetermined sequence of movements is recognized by at least one proximity sensor, when the authentication element, a person or object approaches the vehicle to a first distance within the second area, and retreats again up to a second distance from the vehicle, within a predetermined and defined duration of time.

15. The method, as claimed in claim 14, wherein the predetermined duration of time is defined by a minimum and maximum duration.

16. The method, as claimed in claim 15, wherein at least one proximity sensor is activated cyclically.

17. A remote control system for closure members of vehicles, comprising:
a mobile authentication element; and
a vehicle-side transmitting and/or receiving unit, which drives an actuating mechanism of at least one closure member in response to receipt of an opening command from the authentication element; wherein:
the authentication element comprises at least one actuating element that can be manipulated to perform a predetermined actuating operation;
the predetermined actuating operation activates a transmitter and/or receiver in the authentication element for sending out the opening command;
at least one of i) the act of an authentication element approaching the vehicle and ii) position of a respective authentication element is detected;
the authentication element communicates with a vehicle-sided transmitted and/or receiver for opening at least one closure member; and
communication for opening the at least one closure member is enabled by at least one of a predetermined manual control action of the authentication element before approaching the vehicle and a predetermined sequence of movements of the authentication element after reaching the vehicle.

18. The remote control system, as claimed in claim 17, wherein the opening command for the at least one closure member is a high frequency signal with a first range.

19. The remote control system, as claimed in claim 18, having at least one proximity sensor, which can be activated by the opening command, when the authentication element reaches a predetermined first area around the vehicle equivalent to a range of the opening command, so that at least one proximity sensor detects the continued approach of the authentication element and triggers the opening of at least one closure member when the authentication element reaches a predetermined second area.

20. The remote control system, as claimed in claim 19, having a transmitting and receiving unit, which is located in the vehicle and which can be activated by the opening command; wherein:
the transmitting and receiving unit sends cyclically an authentication signal with a shorter range than the opening signal; and
the authentication signal is answered by a response signal from the authentication element when the authentication element approaches the vehicle to within a second area, thus triggering the opening of at least one closure member.

21. The remote control system for closure members of vehicles for, comprising:
a mobile authentication element;
a vehicle-sided transmitting and/or receiving unit, which drives an actuating mechanism of at least one closure member in response to receipt of an opening command from the authentication element; and
at least one proximity sensor;
the proximity sensor detects approach of the authentication element and activates the transmitter and/or receiver in the vehicle when the authentication element reaches a predetermined area; and
the predetermined sequence of movements is recognized, whereby the transmitting and/or receiving sends an authentication signal, which is answered by the authentication element with the opening command for opening at least one door and/or lid.

22. The remote control system, as claimed in claim 21, wherein the predetermined sequence of movements is recognized by at least one proximity sensor, when the authentication element approaches a first distance from the vehicle which defines the area and then retreats up to a second distance from the vehicle.

23. The remote control system, as claimed in claim 22, wherein:
a dwell period during which the authentication element is in the first distance is compared with a predetermined duration of time; and
the authentication signal is sent, only when the defined duration of time is not exceeded.

24. The remote control system, as claimed in claim 22, wherein the predetermined sequence of movements is recognized by at least one proximity sensor, when the authentication element approaches the vehicle to a first distance within the predetermined area and retreats up to a second distance from the vehicle, within a predetermined duration of time.
